(19) United States
(12) Patent Application Publication
(10) Pub. No.: US 2023/0036110 A1
(43) Pub. Date: Feb. 2, 2023

(54) OPTIMIZATION ENGINE, OPTIMIZATION METHOD, AND PROGRAM

(71) Applicant: NIPPON TELEGRAPH AND TELEPHONE CORPORATION, Tokyo (JP)

(72) Inventors: Hiroya ONO, Musashino-shi, Tokyo (JP); Satoshi NARIKAWA, Musashino-shi, Tokyo (JP)

(73) Assignee: NIPPON TELEGRAPH AND TELEPHONE CORPORATION, Tokyo (JP)

(21) Appl. No.: 17/791,186

(22) PCT Filed: Jan. 23, 2020
(86) PCT No.: PCT/JP2020/002410

§ 371 Date: Jul. 6, 2022

(51) Int. Cl. H04W 48/18; H04W 76/10; H04W 24/02

(52) U.S. Cl. CPC H04W 48/18; H04W 76/10; H04W 24/02

(57) ABSTRACT

An object of the present invention is to provide an optimization engine, an optimization method, and a program that have excellent extensibility, facilitate effective use of unique characteristics of each access network, and can enhance satisfaction levels of diverse users. An optimization engine according to the present invention includes an objective function of an item intended to be improved, collects parameters from access networks and terminals, and finds a combination of connection destinations that maximizes or minimizes the objective function. By appropriately configuring the objective function, it is possible to control user satisfaction levels, bandwidth utilization rates, costs for use of circuits, and the like.

### TECHNICAL FIELD

The present disclosure relates to an optimization engine, an optimization method, and a program that select optimal ones from among a plurality of access networks.

### BACKGROUND ART

When a user uses a network service, the user uses a telecommunication circuit provided by a telecommunication carrier in some cases. For usable circuits, there are various physical media, such as optical circuits and wireless communication circuits. For example, for the optical circuits, telecommunications standards such as IEEE 802.3 (Ethernet(R)) and ITU-T G.983/G.984/G.987/G.989 exist. For the wireless communication circuits, telecommunications standards such as 3GPP 36 Series (LTE), IEEE 802.11 (wireless LAN), and IEEE 802.16 (WiMAX) exist.

A user terminal can perform communication by selectively using a plurality of different telecommunications standards. For example, in a case of a smartphone, a user can select which one of LTE, wireless LAN, and Bluetooth(R) to use. Moreover, circuits of different types of carriers using the same telecommunications standard can also be selectively used.

Since each access network offers different communication quality including a bandwidth, a delay, and the like, such access networks need to be selectively used as appropriate according to a purpose of use. As shown in FIG. 1, a user can manually switch access networks to use, by changing settings on a user terminal. However, when many accessible networks exist, a difficulty arises that a user needs to understand characteristics of each access network and then manually make appropriate settings for selecting an access network.

If a user terminal is connected to an access network that offers communication quality undesirable to a user or that is not suitable for a purpose, communication quality for other user terminals that use the access network is also lowered. As described above, effective use of communication resources in an entire network system possibly cannot be achieved.

For example, in the case of connection to an access network that offers communication quality undesirable to the user, a following situation may occur.

When an attempt is made to use an access network with insufficient radio field strength such as a public wireless LAN in a station or the like, since the number of modulation levels decreases, more communication resources such as time and frequency need to be allocated to the user. In other words, communication quality for other users is greatly degraded, due to the allocation of the communication resources.

In the case of connection to an access network that is not suitable for a purpose of the user, a following situation may occur.

It is assumed that a network (a) with a small total bandwidth but low latency exists. When the user using an application that does not require low latency, such as viewing a video, uses much of the bandwidth of the network (a), a delay increases in communication for a user using an application that requires low latency such as an online game, resulting in a satisfaction level being lowered. In other words, connection to an access network that is not suitable for a purpose may lead to lowering the satisfaction level of another user in some cases.

To overcome the above difficulties, it has been known that a user terminal includes a function of automatically selecting an access network (for example, see Patent Literature 1). The function is a function of predicting communication quality based on a radio field strength or the like of an accessible wireless LAN circuit and preferentially connecting to the wireless LAN circuit when the wireless LAN circuit is expected to ensure sufficient quality and is also accessible.

Such a function estimates communication quality from wireless access information. Accordingly, an error may occur between an estimated value and actual communication quality in some cases, depending on a degree of congestion in a higher-level network and behavior of other user terminals. A problem is addressed that in order to acquire the actual communication quality, it is necessary to connect to a circuit of interest once and measure quality.

Moreover, with the function, since a connection destination of another user terminal cannot be controlled, another problem is also addressed that network optimization in an entire system is difficult. For example, a case is considered in which while a user 1 wants to use an application that requires low-latency communication, a network 2 capable of low-latency communication is already occupied by a terminal of a user 2 who is using an application with a less demanding latency requirement. In such a case, a delay occurs in communication for the user 1, and it is difficult to achieve a satisfaction level of the user 1. On the other hand, communication for the user 2 is in a state of excessive quality. As described above, with the function of Patent Literature 1, service optimization is difficult.

To solve the problems with Patent Literature 1 (to optimize an entire network system), there is a scheme in which a server or a base station device on a network indicates a connection destination to a user terminal (for example, see Non-Patent Literature 1). FIG. 3 is a diagram describing the scheme of Non-Patent Literature 1. When the scheme is used, since connection destinations of a plurality of users can be collectively controlled with a degree of congestion in an entire network taken into consideration, optimization of all users can be realized with accuracy. Non-Patent Literature 1 can enhance throughput of an entire system in an environment in which a 3GPP circuit and a wireless LAN circuit coexist.

### CITATION LIST

### Patent Literature

Patent Literature 1: Japanese Patent Laid-Open No. 2012-169971

### Non-Patent Literature

Non-Patent Literature 1: D. Kimura, “A Novel RAT Virtualization System with Network-Initiated RAT Selection Between LTE and WLAN”, 978-1-5090-4183-1/17, 2017 IEEE
Non-Patent Literature 2: Hiroya Ono, Satoshi Narikawa, “Proposal of automatic optimal access selection scheme adaptive to a multi-access environment”, 2019 IEICE Society Conference, B-6-36
Non-Patent Literature 3: https://business.ntt-east.co.jp/service/azukeru_ms/, retrieved on Dec. 31, 2019
Non-Patent Literature 4:
   https://www.ntt.com/business/services/application/mail-groupware/office365.html, retrieved on Dec. 31, 2019

### SUMMARY OF THE INVENTION

### Technical Problem

The network-initiated connection destination selection algorithm of Non-Patent Literature 1 is an either-or algorithm for switching between LTE and wireless LAN and the like. In other words, Non-Patent Literature 1 has a first problem that it is difficult to extend to environments in which more various types of access networks are accessible.

The selection algorithm of Non-Patent Literature 1 also has a second problem that an objective function for optimization involves only a throughput variable, and it is difficult to enhance a level of user satisfaction with an application that places importance on an indicator other than throughput. In recent years, applications have appeared with which satisfaction levels are greatly affected by delays and fluctuations in delay, and the connection destination selection scheme that takes only throughput into consideration cannot sufficiently enhance user satisfaction levels.

Moreover, each telecommunications standard has a physical property that is determined by radio frequency or the like, as well as unique features that are determined by a service form such as a cost. The selection algorithm of Non-Patent Literature 1 does not take such features into consideration, and selects a connection destination without reflecting characteristics of each access network. In other words, Non-Patent Literature 1 has a third problem that connection destination selection taking characteristics of each access network into consideration is impossible, and in this respect, user satisfaction levels cannot be sufficiently enhanced either.

As means for solving the three problems described above, a scheme is disclosed that optimizes an access destination of a user based on a utility function defined with a plurality of communication quality parameters and a feature of each access method factored in (see Non-Patent Literature 2).

On another front, although conventional data communications were centered on Internet communication, cloud services have been widespread, and low-latency applications have been requested in recent years. To respond to such requests, cases have emerged in which an application server is installed in a network of a telecommunication carrier and is provided, together with a telecommunication circuit, as a service (for example, see Non-Patent Literatures 2, 3). Such cases require that use of the application or reception of the service should be restricted to a network, or connection should be made to a specific network in order to enhance quality of experience of the application.

However, Patent Literature 1 and Non-Patent Literatures 1, 2 are schemes for optimizing a communication path from a higher-level network to the Internet, and do not take into consideration the above-described (1) application that can be used only in coverage of the specific network, and (2) application of which quality of experience is enhanced in coverage of the specific network. Accordingly, Patent Literature 1 and Non-Patent Literatures 1, 2 have a problem that connection is not always made to an access path desired by a user who intends to use any one of the above-described applications.

Accordingly, to solve the problems, an object of the present invention is to provide an optimization engine, an optimization method, and a program that can improve accuracy in selection of a network suitable for an application, and can enhance quality of experience.

### Means for Solving the Problem

To achieve the object, an optimization engine according to the present invention includes an objective function of an item desired to be improved, and is configured to collect parameters from access networks and terminals, and to find a combination of connection destinations that maximizes or minimizes the objective function, taking into consideration a fact that a communication-destination server is installed in a specific access network.

Specifically, an optimization engine according to the present invention is an optimization engine in a communication system, the communication system having a configuration in which each of a plurality of terminals connects to a higher-level network via any one of a plurality of access networks,

the optimization engine including:

an information collection unit that collects, from each of the access networks, communication quality information and a network feature, and collects, from each of the terminals, accessibility information indicating which of the access networks is accessible;

a candidate selection unit that generates, based on the accessibility information, connection destination candidates that are candidates for the access networks to which the terminals respectively connect;

a quality estimation unit that estimates, based on the communication quality information, communication quality with respect to the connection destination candidates to obtain estimated communication quality; and

a determination unit that determines optimal connection destinations from among the connection destination candidates, based on a calculated value obtained by substituting the network feature and the estimated communication quality into a preconfigured objective function, wherein when a specific access network over which a specific application can be used is uniquely determined from among the access networks,

the candidate selection unit treats a fact that the terminal using the specific application connects to the specific access network, as a fixed value, and generates the connection destination candidates.

An optimization method according to the present invention is an optimization method for a communication system,

the communication system having a configuration in which each of a plurality of terminals connects to a higher-level network via any one of a plurality of access networks,

the optimization method including:

collecting, from each of the access networks, communication quality information and a network feature, and collecting, from each of the terminals, accessibility information indicating which of the access networks is accessible;

generating, based on the accessibility information, connection destination candidates that are candidates for the access networks to which the terminals respectively connect; estimating, based on the communication quality information, communication quality with respect to the connection destination candidates to obtain estimated communication quality; and

determining optimal connection destinations from among the connection destination candidates, based on a calculated value obtained by substituting the network feature and the estimated communication quality into a preconfigured objective function,

wherein when a specific access network over which a specific application can be used is uniquely determined from among the access networks, a fact that the terminal using the specific application connects to the specific access network is treated as a fixed value, and the connection destination candidates are generated.

In the present optimization engine and the method for the optimization engine, a combination of connection destinations is selected from among the plurality of access networks, based on the objective function using a plurality of the communication quality parameters and a plurality of the network features as variables. By appropriately configuring the objective function, it is possible to control bandwidth utilization rates, costs for use of circuits, and the like. Connection destinations of the user terminals can be derived according to the arbitrarily configured objective function, by using values that can be acquired from network devices and the user terminals, or values that can be derived from such values.

In the present optimization engine and the method for the optimization engine, a terminal intending to use an application (specific application) for which a service can be received only over one certain access network (specific access network) is connected to the specific access network, without the optimization engine performing calculation processing.

In the present optimization engine and the method for the optimization engine, connection processing is started without waiting for the optimization engine to perform calculation processing, it is easier to follow user movements and application changes, and hence to handle deterioration in a wireless environment. Moreover, in the present optimization engine and the method for the optimization engine, the number of variables in the optimization calculation processing can be reduced, and consequently a time period for the calculation can be reduced, all users can select access networks that follow position information and environmental changes.

Accordingly, the present invention can provide the optimization engine and the optimization method that can improve accuracy in selection of a network suitable for an application, and can enhance quality of experience.

For example, it can be determined that the optimal connection destinations are the connection destination candidates that give a maximum value or a minimum value of the objective function.

The optimization engine according to the present invention further includes a notification unit that outputs a connection instruction to at least one of each of the terminals and each of the access networks such that connections between the terminals and the access networks match the optimal connection destinations.

The optimization method according to the present invention further includes outputting a connection instruction to at least one of each of the terminals and each of the access networks such that connections between the terminals and the access networks match the optimal connection destinations.

A program according to the present invention is a program for causing a computer to function as the optimization engine. The optimization engine according to the present invention can be implemented by the computer and the program, and the program can be recorded in a recording medium, and can also be provided through a network.

### Effects of the Invention

The present invention can provide an optimization engine, an optimization method, and a program that can improve accuracy in selection of a network suitable for an application, and can enhance quality of experience.

### BRIEF DESCRIPTION OF DRAWINGS

FIG. 1 is a diagram describing a communication system related to the present invention.

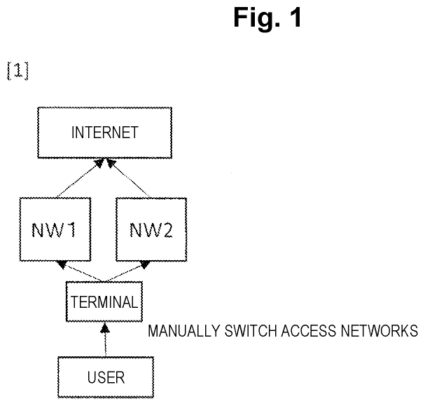

FIG. 2 is a diagram describing a communication system related to the present invention.

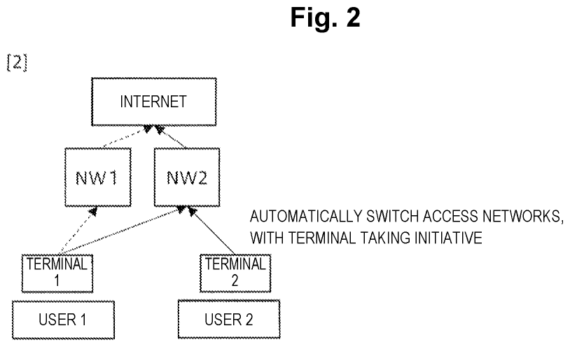

FIG. 3 is a diagram describing a communication system related to the present invention.

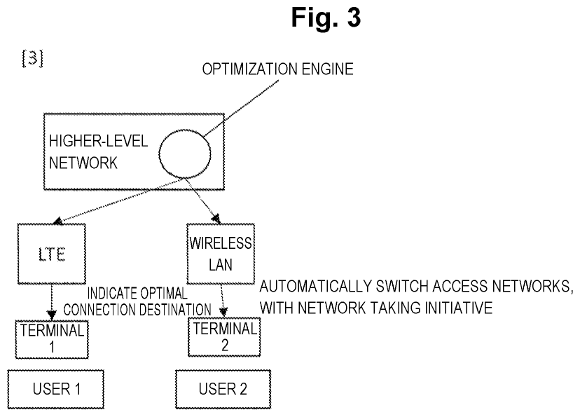

FIG. 4 is a diagram describing a communication system including an optimization engine according to the present invention.

FIG. 5 is a diagram describing the communication system including the optimization engine according to the present invention.

FIG. 6 is a diagram describing the communication system including the optimization engine according to the present invention.

FIG. 7 is a diagram describing operation of the optimization engine according to the present invention.

FIG. 8 is a diagram describing operation of the communication system including the optimization engine according to the present invention.

FIG. 9 is a diagram describing operation of the communication system including the optimization engine according to the present invention.

FIG. 10 is a diagram describing a communication system including an optimization engine according to the present invention.

FIG. 11 is a diagram describing operation of the communication system including the optimization engine according to the present invention.

FIG. 12 is a diagram describing the optimization engine according to the present invention.

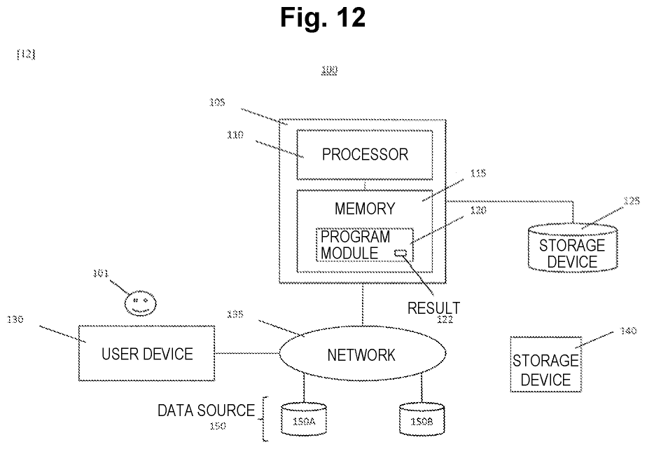

### DESCRIPTION OF EMBODIMENTS

Embodiments of the present invention will be described with reference to the accompanying drawings. The embodiments described below are examples of carrying out the present invention, and the present invention is not limited to the embodiments below. Note that constituent elements denoted by the same reference signs in the description and the drawings are assumed to be constituent elements that are mutually identical.

### Embodiment 1

[Communication System]

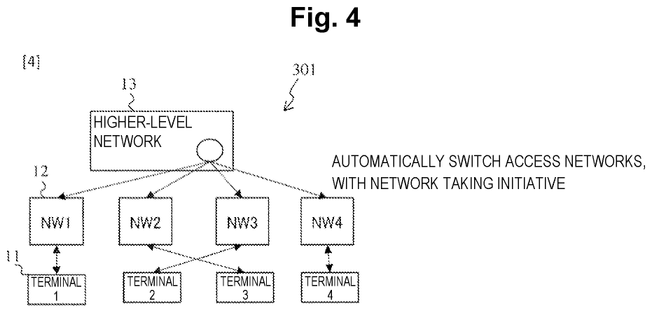

FIG. 4 is a diagram describing a communication system 301 including an optimization engine 50 according to the present embodiment. The communication system 301 has a configuration in which each of a plurality of terminals 11 is connected to a higher-level network 13 via any one of a plurality of access networks (NWs) 12. Although both the terminals 11 and the NWs 12 are four in number in the communication system 301 in FIG. 4, the numbers are not limited to four.

The optimization engine 50 dynamically selects, from among the plurality of NWs 12, a combination of connections that connect the terminals 11 and NWs 12, by calculating an objective function such as a user satisfaction level function that takes a plurality of communication quality parameters and a plurality of network features as variables. Note that “dynamically select” implies periodically calculating the objective function and changing combinations of connections according to a result of the calculation.

The communication quality parameters are parameters related to a total bandwidth, a delay, fluctuations in delay, the number of available TCP sessions, the number of available IP addresses, and other communication quality of a NW.

The network features are values indicating a cost for use of a circuit, user mobility robustness (mobility), presence or absence of encryption, and other network characteristics.

If the communication quality parameters and the network features are values that can be acquired from a network device and a user terminal, or values that can be derived from such values, an NW 12 that each terminal 11 should be connected to is derived according to the arbitrarily configured objective function.

The optimization engine 50 can bring about effects as follows.

(1) In an environment where many NWs 12 exist, an appropriate NW 12 to be used by each terminal 11 can be selected.

(2) When the number of accessible NWs 12 increases, a connection destination selection algorithm can be easily extended.

(3) For an application with which a satisfaction level is associated with a plurality of parameters other than throughput, a terminal 11 can select an NW 12 that makes the satisfaction level higher.

(4) Connections can be made between the terminals 11 and NWs 12, with characteristics of each NW 12 taken into consideration.

(5) Through design of the objective function, connections between the terminals 11 and NWs 12 can be realized that respond to diverse requests, such as maximizing user satisfaction levels, and balancing individual network load factors. In other words, by configuring the objective function as desired in the optimization engine 50, the entire communication system 301 can be controlled, with a bandwidth utilization rate, a cost for use of the circuit, and the like of each NW 12 taken into consideration.

[Supplement]

The “connection destination selection algorithm” refers to a sequential procedure for selecting a connection destination that is a NW to be selected by each user terminal (repeated execution of a procedure including selection of search candidates, quality estimation, and evaluation of the objective function (search loop), after a procedure for configuring the objective function, which will be described later).

The “connection destination selection algorithm can be easily extended” implies that changes in type and number of accessible NWs or a change in number of terminals can be handled only by mainly extending functionality of the quality estimation unit, without needing to change the above-described sequential procedure or the objective function. The reason why the “connection destination selection algorithm can be easily extended” is because each of functional units of configuring an objective function, selecting search candidates, estimating quality, and evaluating the objective function, which will be described later, has a high degree of independence, and functionality extension is easy. In other words, when the number of accessible NWs increases, the increase can be handled only by changing part of the functionality, without needing to greatly change the objective function or a flowchart.

Note that many of conventional connection destination selection algorithms are either-or schemes that select one of a 3GPP circuit and a wireless LAN circuit as in Non-Patent Literature 1, and major alterations in or renewal of an algorithm is needed in order for the algorithm to be applied to three or more NWs. Moreover, in many of such schemes, characteristics of and a relation between the 3GPP circuit and the wireless LAN circuit are reflected directly in a function of selecting a connection destination (a dedicated design is made that selects one of two options, the 3GPP circuit and the wireless LAN circuit), and to introduce a new NW, a function of selecting a connection destination needs to be reconstructed.

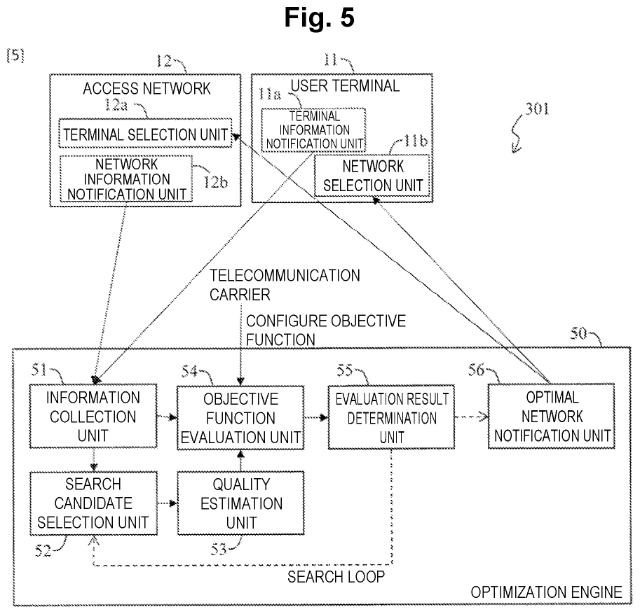

FIG. 5 is a block diagram describing functions of the terminals 11, the access networks 12, and the optimization engine 50.

Each terminal 11 has a terminal information notification unit 11a that notifies an application to use and accessible NWs 12 to the optimization engine 50.

Each terminal 11 has a network selection unit 11b that switches NWs 12 to use, according to an instruction from the optimization engine 50.

Each NW 12 has a terminal selection unit 12a that switches terminals 11 to connect to, according to an instruction from the optimization engine 50. Note that any one of the terminal selection unit 12a of each NW 12 and the network selection unit 11b of each terminal 11 may be used, or both may be used at the same time.

Each NW 12 has a network information notification unit 12b that notifies own communication quality information, such as an available bandwidth, to the optimization engine 50.

The optimization engine 50 has an information collection unit 51 that collects information from the information notification unit 11a of each terminal 11 and the network information notification unit 12b of each NW 12.

The optimization engine 50 has a search candidate selection unit 52 that defines a set of combinations of connections between the terminals 11 and NWs 12, and extracts, from the set, a candidate combination of connections used at a time of search.

The optimization engine 50 has a quality estimation unit 53 that simulates or estimates quality by simulating an actual world. The quality estimation unit 53 receives the candidate combination of connections as an input and outputs estimated quality achieved at each terminal 11 when such connections are made.

The optimization engine 50 has an objective function evaluation unit 54 that calculates a value of the objective function, based on communication quality or the like of each terminal 11.

The optimization engine 50 has an evaluation result determination unit 55 that receives a result of the calculation by the objective function evaluation unit 54, and determines whether to perform again or to finish search for a combination of connections.

The optimization engine 50 has an optimal network notification unit 56 that notifies a combination of connections ultimately determined to at least one of each terminal 11 and each NW 12.

In the optimization engine 50,

the information collection unit 51 collects, from each NW 12, communication quality information (undermentioned “P”) and network features (undermentioned “C”), and collects, from each terminal 11, accessibility information (undermentioned “A”) indicating which NW 12 is accessible;

the search candidate selection unit 52 generates, based on the accessibility information, connection destination candidates (a combination of connections) that are candidates for NWs 12 to which the terminals 11 respectively connect;

the quality estimation unit 53 estimates communication quality (outputs estimated communication quality) with respect to the connection destination candidates, based on the communication quality information;

the objective function evaluation unit 54 substitutes the network features and the estimated communication quality into a preconfigured objective function; and the evaluation result determination unit 55 determines that the connection destination candidates that give a maximum value or a minimum value of the objective function are optimal connection destinations.

Then, the optimal network notification unit 56 outputs a connection instruction to at least one of each terminal 11 and each NW 12 such that connections between the terminals 11 and the NWs 12 match the optimal connection destinations.

[Operation]

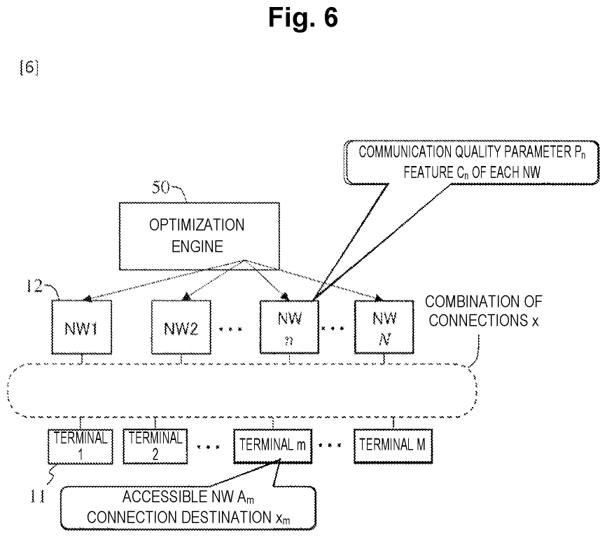

FIG. 6 is a diagram describing operation of the optimization engine 50. It is assumed that each terminal 11 can use N types of NWs 12 at the maximum within the communication system. It is assumed that an array of values of communication quality parameters, such as a total bandwidth and an average delay, of an n-th NW 12 is represented by a vector Pₙ. Moreover, it is assumed that an array of features of the n-th NW 12, other than the communication quality, is represented by a vector Cₙ. The numbers of elements of the vector Pₙ and the vector Cₙ are equal to the numbers of communication quality parameters and features taken into consideration, respectively. Further, it is assumed that a set of vectors Pₙ is a set P, and that a set of vectors Cₙ is a set C.

[Math. 1]

P={Pₙ|1≤n≤N}

C={Cₙ|1≤n≤N} (1)

Note that the vector Cₙ may include a list of an application that can be implemented within the n-th NW 12.

M terminals 11 are present within the communication system. It is assumed that an array indicating NWs 12 accessible to an m-th terminal 11 is a vector Aₘ, and that a set of vectors Aₘ is a set A. Numbers for the accessible NWs 12 are described in the vector Aₘ, and the number of elements of the vector Aₘ is equal to the number of the accessible NWs 12. Alternatively, the vector Aₘ may be defined by an array with N elements in which an i-th component “A_{m,i}” of the vector Aₘ is represented by a following expression.

$$\begin{matrix}[ Math . 2 ] & \\ {A}_{m , i} = \{ \begin{matrix}0 & if i - th access network is inaccessible \\ 1 & if i - th access network is accessible\end{matrix} & ( 2 )\end{matrix}$$

$$\begin{matrix}[ Math . 3 ] & \\ A = [ {A}_{m} \vert 1 \leq m \leq M ] & ( 3 )\end{matrix}$$

Note that the vector Aₘ may include information on an application that the m-th terminal 11 uses (application information).

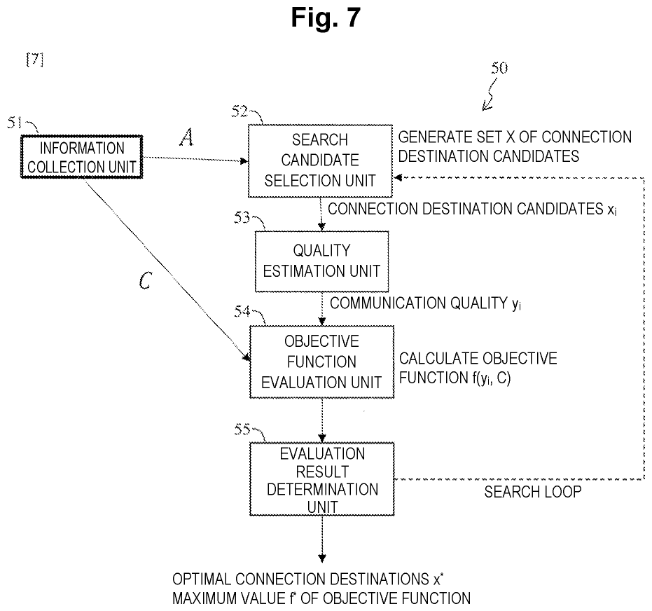

FIG. 7 is a diagram describing operation of the optimization engine 50.

A combination of NWs 12 to which the M terminals 11 are connected is represented by a vector x, and an m-th element xₘ of the vector x indicates the number for an NW 12 to which the m-th terminal 11 is connected (1≤xₘ≤N).

The search candidate selection unit 52 of the optimization engine 50 receives, as input, accessible access networks A that are a set of the vectors Aₘ representing NWs 12 accessible to the individual terminals 11, and generates a set X of connection destination candidates of the individual terminals.

The vector x is a vector in which the number xₘ for a connection destination NW to which each m-th terminal is connected is arrayed with respect to all terminals. In some cases, the vector x is stated as a “combination of connections”. In contrast, the vector Aₘ is a vector in which the numbers for NWs that are accessible to (are connection candidates of) the m-th terminal are arrayed.

The search candidate selection unit 52 generates the set X containing the connection destination candidates of all terminals, by using the set A of the vectors Aₘ of all terminals. Moreover, for a first time (i=1) of the search loop, the search candidate selection unit 52 selects one connection candidate from the set X for each terminal and arrays the selected connection candidates to obtain a vector of connection destination candidates x₁, which are then inputted into the quality estimation unit 53. For each time of the search loop, the search candidate selection unit 52 changes the connection candidate of at least one terminal to obtain a new vector of connection destination candidates xᵢ. In other words, a combination of connections x is changed for each time of the search loop.

The quality estimation unit 53 receives the connection destination candidates xᵢ from the search candidate selection unit 52, and calculates communication quality yᵢ for the terminals as a whole. The communication quality yᵢ is a vector, and is a function (yᵢ(xᵢ)) of the connection destination candidates xᵢ. An m-th component “yᵢ,m” of the communication quality yᵢ is communication quality acquired at the m-th terminal in a case of a combination of connections for a time of a search loop i.

It is assumed that the objective function configured in the objective function evaluation unit 54 is “f(yᵢ(xᵢ), C)”. It is assumed that a maximum value or a minimum value of the objective function obtained up until the i-th time of the search loop is “f*”. It is assumed that when “f*” is obtained, the then connection destination candidates are “x*”. The objective function evaluation unit 54 outputs the connection destination candidates x* by calculating a following expression by using the set C of features acquired from the information collection unit 51, the communication quality yᵢ(xᵢ), and the objective function.

$$\begin{matrix}[ Math . 4 ] & \\ {x}^{⋆} = {arg max}_{1 \leq k \leq i} f ( {y}_{k} ( {x}_{k} ) , C ) & ( 4 )\end{matrix}$$

$$or$$

$${x}^{⋆} = {arg min}_{1 \leq k \leq i} f ( {y}_{k} ( {x}_{k} ) , C )$$

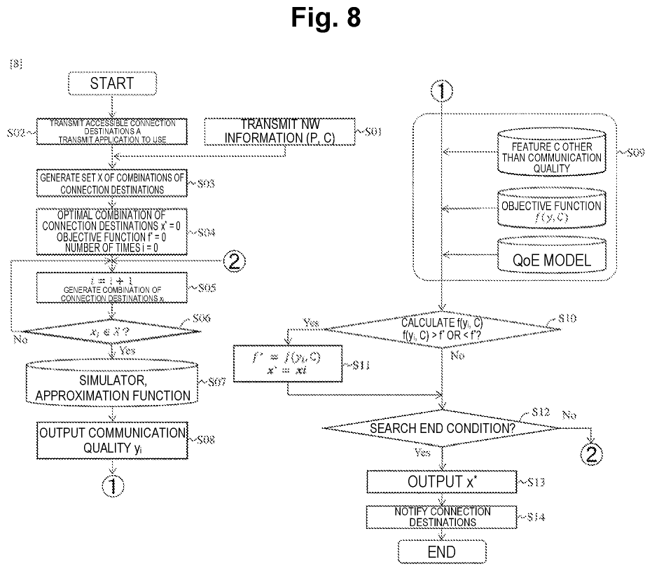

FIG. 8 is a flowchart describing operation of the communication system 301.

The network information notification unit 12b of each NW 12 notifies communication quality information (vector Pₙ) and features (vector Cₙ) other than the communication quality to the information collection unit 51 of the optimization engine 50. Note that if there is an application that can be implemented within an NW 12, the network information notification unit 12b of the NW 12 may notify a list of such an application. The information collection unit 51 generates a set P and a set C from the notified communication quality information and features.

The information notification unit 11a of each terminal 11 notifies access networks accessible at an arbitrary time point and an application that the terminal 11 is using or will use (vector Aₘ) to the information collection unit 51 of the optimization engine 50 (step S02). The information collection unit 51 generates accessible applications (set A) from the notified applications.

The notification of the information in step S01 and step S02 may be performed in any order, or may be performed at the same time. No restriction is imposed on order of the terminals or order of the networks. The above-described steps do not need to be performed, and may be preconfigured when states of the terminals and the networks are known and no dynamic changes occur.

The search candidate selection unit 52 of the optimization engine 50 generates a set X of combinations of terminal connection destinations by using the set A (step S03).

The search candidate selection unit 52 initializes the number of times i of the solution search loop, the maximum or minimum value f* of values of an objective function, and the then connection destinations x* (initial values are set to zero or a zero vector).

Step S03 and step S04 may be performed in any order, or may be performed at the same time.

The search candidate selection unit 52 of the optimization engine 50 extracts elements xᵢ from the set X of connection destination candidates. The quality estimation unit 53, by using the set P, estimates communication quality yᵢ achieved when the elements xᵢ are used as input (steps SS05 to S08). For a method of extracting the elements xᵢ, a method of extracting elements from X at random, or a method of extracting every element in specific order may be used. A method may also be used in which elements xᵢ are generated in a random manner, and quality estimation is performed only for an element that is confirmed as satisfying “xᵢ e X” (step S06).

For a method of estimating the communication quality yᵢ (step S07), any method may be used. For example, for the method, there is a method of outputting a result of performing simulation with a system in which distributions of actual networks and users are simulated. In addition to throughput, a communication delay and the like can also be estimated by using “ns-3”, “QualNet”, “OpNet Modeler”, and any other network simulators. When it is desired to estimate only throughput, a method of performing estimation in a simplified manner may also be used, such as dividing a total bandwidth of each network by the number of people who connects to the network.

The objective function evaluation unit 54, by using the preconfigured objective function f(yᵢ, C), calculates values of the objective function from the communication quality yᵢ obtained with respect to the elements xᵢ that are connection destination candidates and the features C other than the communication quality (step S10). For example, when the objective function f(yᵢ, C) includes QoE (Quality of experience) representing a user satisfaction level, the objective function evaluation unit 54 uses a QoE model determined based on the application used by each terminal, which is acquired in step S02 (step S09) and derives a value of QoE from the communication quality yᵢ and the features C. More specifically, assuming that web browsing is performed as an application, QoE can be estimated from the communication quality yᵢ, by using a QoE model for web browsing, a bandwidth required for web pages, and an average throughput.

For an i-th time of the search loop, when the objective function f(yᵢ, C) is larger than a maximum value f* obtained through previous searches (calculation up until an (i−1)-th time of the search loop) (“Yes” in step S10), the evaluation result determination unit 55 updates f* to the value of the objective function f(yᵢ, C) for the i-th time of the search loop. Moreover, the evaluation result determination unit 55 performs updating such that the elements xᵢ used when the f* is obtained become x* (step S11).

In a case of the objective function that is a function to be minimized, the evaluation result determination unit 55 updates f* when f(yᵢ, C) is smaller than a minimum value f* obtained through previous searches (“Yes” in step S10). The evaluation result determination unit 55 performs updating such that the elements xᵢ used when the f* is obtained become x* (step S11).

The solution search loop comes to an end when a search end condition, which is “being performed as many n times as the number of elements in X” or is predetermined, is met (“Yes” in step S12). When the search end condition is not met, the search loop is repeated from step S05 (“No” in step S12).

Specifically, for the search end condition, any of the following may be used.

(1) Number of searches (an upper limit to i)

(2) Time period for search

(3) Fact that a value of a specific indicator or the objective function exceeds or falls below a certain value

(4) Fact that x* obtained in the middle of search produces a value that clearly will not be updated in the future

When the search is finished, the optimal access network notification unit 56 of the optimization engine 50 notifies a connection destination, based on x*, to at least one of the network selection unit 11b of each terminal 11 and the terminal selection unit 12a of each NW 12 (step S13, S14). The terminals 11 and the NWs 12 having received the notification switch connection destinations in accordance with the notification. After each of the terminals 11 and the NWs 12 switches connection destinations, the terminals 11 and the NWs 12 fall in a state corresponding to x*.

### Embodiment 2

In the present embodiment, a case will be described in which a specific access network (specific NW) over which a specific application can be used is uniquely determined from among NWs 12. A configuration of a communication system in the present embodiment is the same as the access networks 12 and the optimization engine 50 shown in FIG. 5. In the present embodiment, the candidate selection unit 52 reflects a fact, as a fixed value, that a terminal 11 uses the specific application over the specific NW, in a set X of connection destination candidates.

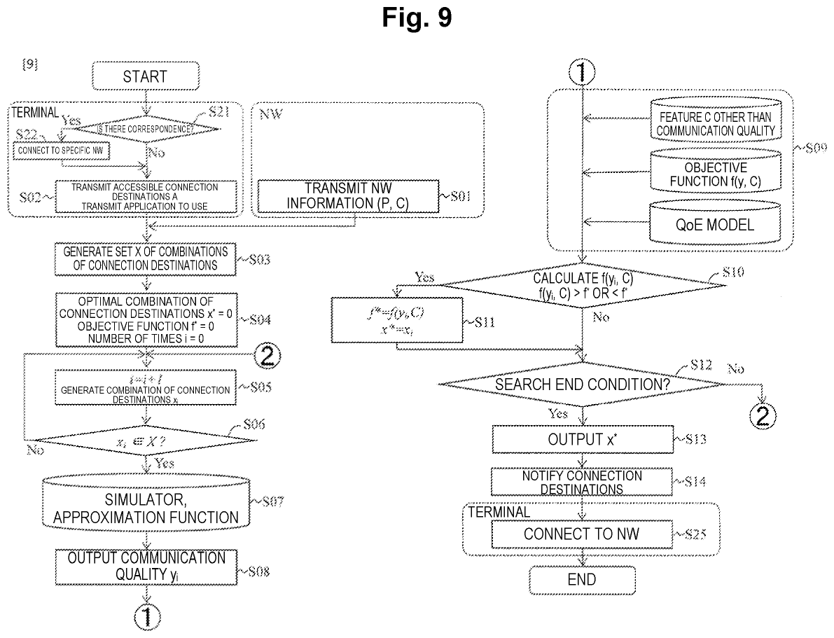

FIG. 9 is a flowchart describing operation of the communication system according to the present embodiment. Differences of the present flowchart from the flowchart in FIG. 8 describing the operation of the communication system 301 are steps S21, S22, and S25. Before step S02 is performed, each terminal 11 determines whether or not there is any case in which a specific NW over which a specific application can be used is uniquely determined from among NWs 12 (step S21). Note that a “correspondence” refers to a relation in a case where an application that a user m intends to use can be used only over one NW 12, or where quality of experience is expected to increase over one NW 12, and such an application is referred to as a “specific application”, and such “one NW 12” is referred to as a “specific NW”. Moreover, a terminal using a specific application is referred to as a “specific terminal”.

In a case of a terminal with no correspondence (“No” in step S21), the terminal performs step S02, and operation is performed as in the flowchart in FIG. 8. In a case of a specific terminal with a correspondence (“Yes” in step S21), the specific terminal voluntarily connects to the specific NW without waiting for a notification from the optimization engine 50 (step S22). Thereafter, in step S02, the specific terminal transmits a vector Aₘ in which a fact that the specific terminal is connected to the specific NW is reflected. In step S03, the search candidate selection unit 52 generates combinations X of connection destinations in which the fact that the specific terminal is connected to the specific NW is reflected. In other words, the optimization engine 50 treats the connection destination of the specific terminal that is connected to the specific NW in advance as a fixed value, calculates connection destinations of the other terminals 11 as variables, and derives optimal connection destinations of the other terminals 11. Since a connection destination is treated as a fixed value with respect to the specific terminal 11 and the number of variables is consequently reduced as a whole, a time period for the quality estimation unit 53 to calculate communication quality yᵢ is shortened, compared to the case in FIG. 8.

Thereafter, the optimization engine 50 performs steps S04 to S13 as described in FIG. 8, and notifies the connection destinations to the other terminals 11 or the NWs 12 (step S14).

Here, regarding a method for exchanging information between a terminal 11 and the optimization engine 50, and an entity that takes the initiative in determining an NW 12, a specific example will be described.

As types of specific application, two cases are conceivable in which a service can be received only in coverage of a specific NW, and in which utility is relatively enhanced when a specific NW is used. The following specific example can be applied to both of the cases. Although the former case will be described here, the description can be interpreted by replacing “can be used” with “utility is enhanced” in the latter case.

For understanding, the specific example is illustrated by using symbols. It is assumed that information “in a situation where NWs 12-1, 12-2, and 12-3 are accessible to a terminal 11, an application A can be used only over the NW 12-1 (a specific NW is the NW 12-1)” is represented by
{N (1, 2, 3), A(1)}.

A case in which an NW over which the application A can be used is unknown is represented by
{N (1, 2, 3), A(?)}.

In the present embodiment, in step S02, the terminal 11 notifies information on the accessible NWs and the application to use (including information on the NW over which a service can be used) to the optimization engine 50.

The information is {N(1, 2, 3), A(1)}.

When an NW that is accessible and over which the application can be used is uniquely determined, the terminal voluntarily connects to the NW, and notifies the actual connection destination to the optimization engine.

The present embodiment provides the method that is effective when a terminal has sufficient application information, and NWs can be selected with a shorter waiting time.

### Embodiment 3

In the present embodiment, a case will be described also in which a specific access network (specific NW) over which a specific application can be used is uniquely determined from among NWs 12. In the present embodiment, the candidate selection unit 52 also reflects a fact, as a fixed value, that a terminal 11 uses the specific application over the specific NW, in a set X of connection destination candidates.

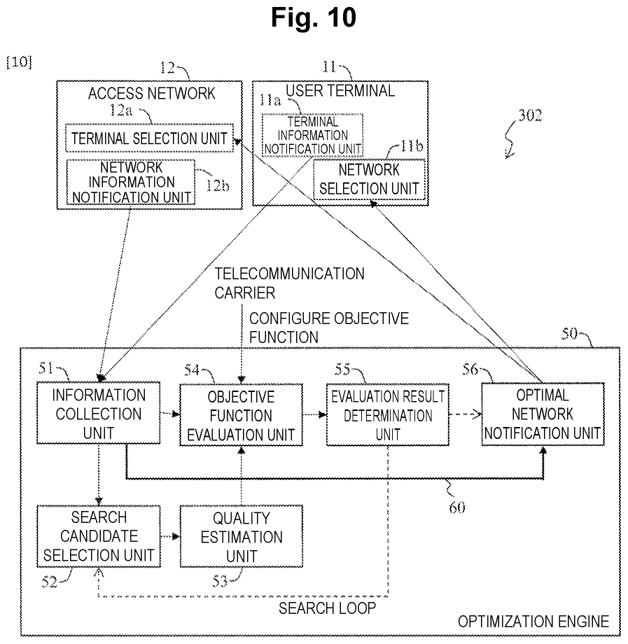

FIG. 10 is a block diagram describing a configuration of a communication system 302 according to the present embodiment. The communication system 302 includes terminals 11, access networks 12, and an optimization engine 50. The optimization engine 50 differs from the optimization engine 50 in the communication system 301 shown in FIG. 5 in a point that in some cases, the information collection unit 51 directly gives the optimal network notification unit 56 an instruction that a terminal 11 intending to use a specific application should be connected to a specific NW (a sign 60).

In the communication system 302, mainly the evaluation result determination unit 55 inputs an optimal combination of connections between the terminals 11 and NWs 12 into the optimal network notification unit 56. Moreover, in the communication system 302, when the number of NWs that can be used by a terminal 11, which is determined by the number of NWs accessible to the terminal 11 and an application, is one, the NW 12 to which the terminal 11 should be connected to is directly outputted from the information collection unit 51 to the optimal network notification unit 56.

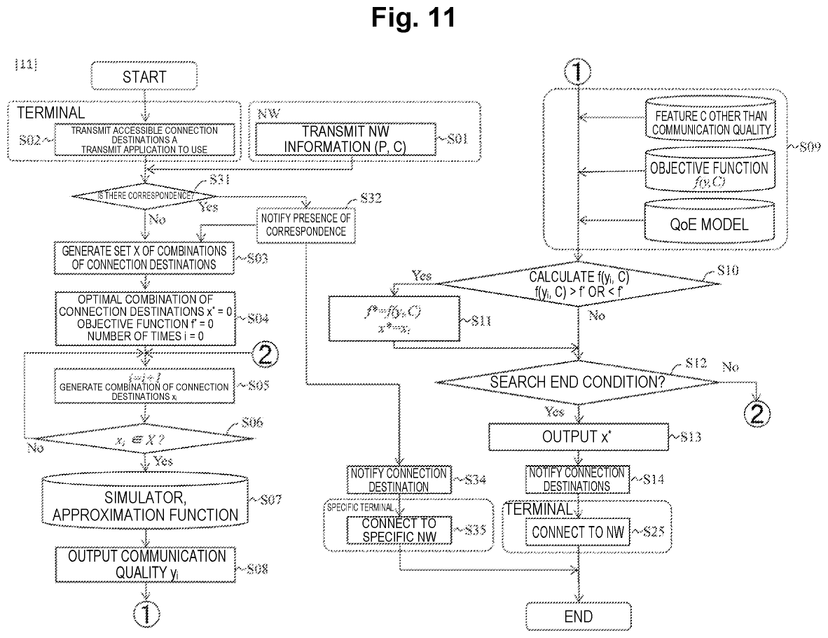

FIG. 11 is a flowchart describing operation of the communication system 302. Differences of the present flowchart from the flowchart in FIG. 8 describing the operation of the communication system 301 are steps S31, S32, S34, and S35. Before step S02 is performed, the information collection unit 51 determines whether or not there is any case in which a specific NW over which a specific application can be used is uniquely determined from among NWs 12 (step S31). Note that a “correspondence” refers to a relation in a case where an application that a user m intends to use can be used only over one NW 12, or where quality of experience is expected to increase over one NW 12, and such an application is referred to as a “specific application”, and such “one NW 12” is referred to as a “specific NW”. Moreover, a terminal using a specific application is referred to as a “specific terminal”.

In a case of a terminal with no correspondence (“No” in step S31), the search candidate selection unit 52 performs step S03, and operation is performed as in the flowchart in FIG. 8. In a case of a specific terminal with a correspondence (“Yes” in step S31), the information collection unit 51 notifies presence of the specific terminal to the optimal network notification unit 56 (the sign 60 in FIG. 10). Note that the information collection unit 51 notifies presence of the correspondence to the search candidate selection unit 52, in order to evaluate connection destinations of the other terminals (step S32). The optimal network notification unit 56 notifies the connection destination, without waiting for a notification from the evaluation result determination unit 55 (without waiting for steps S03 to S13 to be performed), to the specific terminal such that the specific terminal connects to the specific NW, or to the specific NW such that the specific NW connects to the specific terminal (step S34). The specific terminal connects to the specific NW (step S35).

The optimization engine 50 performs steps S03 to S13 with respect to the other terminals than the specific terminal, and notifies evaluated connection destinations to the other terminals or the NWs 12 (step S14). The other terminals connect to the NWs 12 in accordance with the notification (step S25).

In other words, in the present embodiment, when an application that a user m intends to use can be used only over a specific NW or when quality of experience is expected to increase over a specific NW, a terminal of the user receives an instruction about a connection destination from the optimization engine 50 at a time point of step S31, and is connected to the specific NW.

In step S03, the search candidate selection unit 52 generates combinations X of connection destinations in which a fact that the specific terminal is connected to the specific NW is reflected. In other words, the optimization engine 50 treats the connection destination of the specific terminal as a fixed value, calculates connection destinations of the other terminals 11 as variables, and derives optimal connection destinations of the other terminals 11. Since a connection destination is treated as a fixed value with respect to the specific terminal and the number of variables is consequently reduced as a whole, a time period for the quality estimation unit 53 to calculate communication quality yᵢ is shortened, compared to the case in FIG. 8.

Here, regarding a method for exchanging information between a terminal 11 and the optimization engine 50, and an entity that takes the initiative in determining an NW 12, specific examples will be described.

As types of specific application, two cases are conceivable in which a service can be received only in coverage of a specific NW, and in which utility is relatively enhanced when a specific NW is used. The following specific examples can be applied to both of the cases. Although the former case will be described here, the description can be interpreted by replacing “can be used” with “utility is enhanced” in the latter case.

For understanding, the specific examples are illustrated by using symbols. It is assumed that information “in a situation where NWs 12-1, 12-2, and 12-3 are accessible to a terminal 11, an application A can be used only over the NW 12-1 (a specific NW is the NW 12-1)” is represented by
{N (1, 2, 3), A(1)}.

A case where an NW over which the application A can be used is unknown is represented by
{N (1, 2, 3), A(?)}.

### Example 1

In the present example, in step S02, the terminal 11 notifies information on the accessible NWs and the application to use (including information on the NW over which a service can be used) to the optimization engine 50.

The information is {N(1, 2, 3), A(?)}.

When an NW that is accessible and over which the application can be used is uniquely determined, the optimization engine 50 instructs the terminal 11 to connect to the NW, and the terminal 11 switches NWs in accordance with the instruction.

The present example is an example that is feasible when the optimization engine 50 grasps relations between applications and NWs even if a terminal 11 does not sufficiently have application information.

### Example 2

In the present example, in step S02, the terminal 11 notifies information on the accessible NWs and the application to use (including information on the NW over which a service can be used) to the optimization engine 50.

The information is {N(1, 2, 3), A(1)}.

When an NW that is accessible and over which the application can be used is uniquely determined, the optimization engine 50 instructs the terminal 11 to connect to the NW, and the terminal 11 switches NWs in accordance with the instruction.

In the present example, since the optimization engine does not need to perform distributed control of each terminal and information management related to reports of the control, implementation of the optimization engine can be simplified.

### Example 3

In the present example, in step S02, the terminal 11 derives a common NW, which is both a NW that is accessible to the terminal 11 and a NW over which the application can be used, and notifies a list corresponding to the common NW as an “NW that can be used” to the optimization engine 50.

Such information is {N(1), A(?)}, {N(1), A(1)}, or {N(1)}.

When an NW that is accessible and over which the application can be used is uniquely determined, the optimization engine 50 instructs the terminal 11 to connect to the NW, and the terminal 11 switches NWs in accordance with the instruction.

In the present example, while the processing by the optimization engine can be simplified as in the example 2, an amount of computation by the optimization engine and an amount of communication with terminals can be restrained.

### Specific Examples of the Objective Function

A setter of the objective function determines the objective function, taking into consideration a business model, user satisfaction levels, fairness, costs, or the like. Assignment of connection destinations of users can be performed based on various policies, through configuration of the objective function f(y, C).

Examples of the objective function are listed below.

(1) Total value of estimated values of satisfaction level (maximization)

$$\begin{matrix}[ Math . P1 ] & \\ f ( y , C ) = {\sum }_{m = 1}^{M} {h}_{m} & ( P1 )\end{matrix}$$

where hₘ is an estimated value of the satisfaction level of a user m.

(2) Number of users with estimated values of satisfaction level that are equal to or larger than a set value (maximization)

[Math. P2]

f(y,C)=n(A)

A={hₘ≥hₒ} (P2)

where “hₒ” is a constant.

(3) Median of estimate values of satisfaction level (maximization)

[Math. P3]

f(y,C)median(hₘ) (P3)

(4) Variance of estimate values of satisfaction level (minimization)

$$\begin{matrix}[ Math . P4 ] & \\ f ( y , C ) = \frac{1}{M} {\sum }_{m = 1}^{M} {( {h}_{m} - \overline{h} )}^{2} & ( P4 )\end{matrix}$$

$$\overline{h} = \frac{1}{M} {\sum }_{m = 1}^{M} {h}_{m}$$

(5) Satisfaction level of a user with the smallest estimated value of satisfaction level (maximization)

$$\begin{matrix}[ Math . P5 ] & \\ f ( y , C ) = {min}_{1 \leq m \leq M} {h}_{m} & ( P5 )\end{matrix}$$

(6) Imbalance of network loading factors (minimization)

$$\begin{matrix}[ Math . P6 ] & \\ f ( y , C ) = \vert \frac{{l}_{a} - {l}_{b}}{{l}_{a} + {l}_{b}} \vert & ( P6 )\end{matrix}$$

where “lₐ” and “l_{b}” are bandwidth utilization rates of access networks A and B, respectively.

Note that when three or more access networks exist, variance of respective bandwidth utilization rates lₙ of the access networks may be used (in the present expression, “n” denotes an identification number for an access network).

$$\begin{matrix}[ Math . P6a ] & \\ f ( y , C ) = \frac{1}{N} {\sum }_{n = 1}^{N} {( {l}_{n} - \overline{l} )}^{2} & ( P6a )\end{matrix}$$

$$\overline{l} = \frac{1}{N} {\sum }_{n = 1}^{N} {l}_{n}$$

(7) Difference from desired allocations of network loading factor (minimization)

$$\begin{matrix}[ Math . P7 ] & \\ f ( y , C ) = \vert \frac{γ {l}_{a} - {l}_{b}}{γ {l}_{a} + {l}_{b}} \vert & ( P7 )\end{matrix}$$

where “γ” is b/a when it is desired that lₐ:l_{b} is a:b. “a” and “b” are positive numbers. For example, when connection destinations are assigned such that the bandwidth utilization rates of the network A and the network B satisfies a ratio of lₐ:l_{b}=3:4, a=3, b=4.

Note that when a plurality of (N) access networks exist, a following objective function is obtained as a result of generalizing Math. P7.

$$\begin{matrix}[ Math . P7a ] & \\ f ( y , C ) = \frac{1}{N} {\sum }_{n = 1}^{N} {( {l}_{n} - {γ}_{n} {l}_{o} )}^{2} & ( P7a )\end{matrix}$$

where “lₒ” and “lₙ” are bandwidth utilization rates of a reference access network and an n-th access network (n is an integer equal to or smaller than N; excluding the reference access network), respectively. “γₙ” is a value of a ratio between the bandwidth utilization rates of the reference network and the n-th network. In other words, “γₙ” is a value in a case where the bandwidth utilization rate 10 of the reference network and the bandwidth utilization rate lₙ of the n-th network satisfies lₒ:lₙ=1:γₙ.

(8) Total value of costs for use of circuits viewed from a mobile virtual network operator (MVNO) (minimization)

$$\begin{matrix}[ Math . P8 ] & \\ f ( y , C ) = {\sum }_{n = 1}^{N} {p}_{n} {B}_{n} & ( P8 )\end{matrix}$$

where pₙ is a charge for use of a circuit per band of an access network n, and Bₙ is an amount of data used per unit time over the access network n.

When the objective functions of Maths. P1, P2, P3, and P5 are configured, optimization is performed in step S10 in FIG. 8 such that the objective functions are maximized. In contrast, when the objective functions of Maths. P4, P6, P7, and P8 are configured, optimization is performed in step S10 in FIG. 8 such that the objective functions are minimized.

Moreover, the user satisfaction level used in Maths. P1 and P2 is assumed to be an indicator that takes into consideration both QoE (Quality of experience) determined by communication quality for each application, and an effect α(C) of an array Cn of features of each access network other than the communication quality. Specifically, the user satisfaction level is defined as follows.

[Math. P9]

hₘ=α(C)×QoE(y) (P9)

When it is desired to make balanced enhancements of a plurality of objective functions f₁(y, C), f₂(y, C), . . . , an objective function f(y, C) synthesized from the plurality of objective functions is configured. When different degrees of importance are placed on objective functions fⱼ(y, C), each fⱼ(y, C) can be weighted individually (j is a natural number). Hereinafter, examples of a method for synthesizing objective functions will be described. Here, a vector w is an array of proportions of weighting.

[Math. 5]

w={w₁,w₂. . . wⱼ. . . |ΣWₖ−1} (5)

(A) Method using a sum for representation

[Math. 6]

f(y,C)=Σwⱼfⱼ(y,c) (6)

(B) Method using a product for representation

[Math. 7]

f(y,C)=Πfⱼ(y,C)^{w}^{ⱼ} (7)

(C) Method using a sum or a product for representation after substitution by another function

When the basic objective functions represented by Maths. P1 to P8 are synthesized, the individual objective functions cannot be considered in a balanced manner with the above methods (A) and (B), in some cases. For example, when it is desired to consider an objective function to be maximized and an objective function to be minimized at the same time, synthesis needs to be performed after any one of the functions is transformed such as by inverting values. When there is a difference between ranges of possible values of the individual functions, an effect can be seen, such as an objective function with a wider range of values having more contribution. Accordingly, when it is desired to equally consider a plurality of objective functions, standardization to adjust allowable ranges is required in some cases. A function used for such transformation is configured as “g”, and an objective function f can be represented also by a synthesized function of “g” and “fⱼ”.

For example, the objective function f can be configured as follows.

[Math. 8]

f(y,c)=Σwⱼg(fⱼ(y,C))

f(y,C)=Πg(fⱼ(y,c))^{w}^{ⱼ} (8)

Here, when it is desired to transform a function to be minimized into a function to be maximized, a following function may be configured.

$$\begin{matrix}[ Math . 9 ] & \\ g ( {f}_{j} ( y , C ) ) = \frac{1}{{f}_{j} ( y , C ) )} & ( 9 )\end{matrix}$$

When it is desired to transform a function to be maximized into a function to be minimized, transformation may be performed also by using a similar function.

Moreover, as an example of the function g that transforms a range of possible values, a sigmoid function of Math. 10 can also be configured. In such a case, g(fⱼ(y, C)) ∈[0, 1], with respect to a value of arbitrary f (y, C).

$$\begin{matrix}[ Math . 10 ] & \\ g ( {f}_{j} ( y , C ) ) = \frac{1}{1 + exp ( - a ( {f}_{j} ( y , C ) - {f}_{0} )} & ( 10 )\end{matrix}$$

where “a” and “fₒ” are constants.

As another example of the function g, Math. 11 can also be configured. In such a case, g(fⱼ(y, C)) ∈[0, 1], under a condition that fⱼ(y, C)≥0.

$$\begin{matrix}[ Math . 11 ] & \\ g ( {f}_{j} ( y , C ) ) = 1 - exp ( - \frac{{f}_{j} ( y , C ) - {f}_{0}}{a} ) & ( 11 )\end{matrix}$$

where “a” and “fₒ” are constants.

When a plurality of transformations are needed, a plurality of functions gₖ and gₗ may be used at the same time. The function g ultimately used in such a case may be defined as follows.

[Math. 12]

g(fⱼ(y,C))=gₖ·gₗ·fⱼ)(y,C) (12)

The function g ultimately used may be a synthesized function of three or more functions.

### Examples of Implementing the Optimization Engine

The above-described optimization engine 50 can also be implemented by a computer and a program, and the program can be recorded on a recording medium, and can also be provided through a network.

FIG. 11 shows a block diagram of a system 100. The system 100 includes a computer 105 connected to a network 135. Note that the system 100 corresponds to the communication system 301, and the computer 105 corresponds to the optimization engine 50.

The network 135 is a data communication network. The network 135 may be a private network or a public network, and can include any or all of (a) a personal area network covering, for example, a certain room, (b) a local area network covering, for example, a certain building, (c) a campus area network covering, for example, a certain campus, (d) a metropolitan area network covering, for example, a certain metropolitan area, (e) a wide area network covering regions connected across a boundary or boundaries between metropolitan areas, rural areas, or countries, and (f) the Internet. Communication is performed over the network 135 by using an electronic signal or an optical signal. Note that the network 135 corresponds to the NWs 12 and the higher-level network 13.

The computer 105 includes a processor 110 and a memory 115 connected to the processor 110. The computer 105 is illustrated as a stand-alone device in the present description but is not limited thereto, and may rather be connected to another undepicted device in a distributed processing system.

The processor 110 is an electronic device configured by using logic circuitry that responds to a command and executes the command.

The memory 115 is a tangible computer-readable storage medium in which a computer program is encoded. In this respect, the memory 115 stores data and commands, that is, program codes that are readable and executable by the processor 110 in order to control operation of the processor 110. The memory 115 can be implemented by a random access memory (RAM), a hard drive, a read-only memory (ROM), or a combination thereof. One of constituent elements of the memory 115 is a program module 120.

The program module 120 includes commands for controlling the processor 110 such that the processor 110 executes the processes described in the present description. Although it is described that the operations are performed by the computer 105, a method, processes, or lower-order processes in the present description, the operations are actually executed by the processor 110.

In the present description, the term “module” is used to refer to functional operations that can be implemented as a stand-alone constituent element or an integrated configuration including a plurality of lower-order constituent elements. Accordingly, the program module 120 can be implemented as a single module, or a plurality of modules that operate in coordination with each other. Moreover, although it is described that the program module 120 is installed into the memory 115, and is therefore implemented as software in the present description, the program module 120 can be implemented as hardware (for example, an electronic circuit), firmware, software, or a combination thereof.

Although it is illustrated that the program module 120 is already loaded onto the memory 115, the program module 120 may be configured to be located on a storage device 140 so as to be loaded onto the memory 115 later. The storage device 140 is a tangible computer-readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory, or any other type of electronic storage device that is located in an undepicted remote storage system and is connected to the computer 105 via the network 135.

The system 100 further includes a data source 150A and a data source 150B that are collectively referred to as a data source 150 in the present description and are communicably connected to the network 135. In actuality, the data source 150 can include any number of data sources, that is, one or more data sources. The data source 150 includes unsystematized data, and can include a social medium.

The system 100 further includes a user device 130 that is operated by a user 101 and is connected to the computer 105 via the network 135. For the user device 130, an input device can be cited, such as a key board or a voice recognition subsystem for enabling the user 101 to convey information and selection of a command to the processor 110. The user device 130 further includes an output device such as a display device, a printer, or a voice synthesis device. A cursor control unit such as a mouse, a trackball, or a touch-sensing screen enables the user 101 to operate a cursor on the display device in order to convey further information and selection of a command to the processor 110. Note that the user device 130 corresponds to a terminal 11.

The processor 110 outputs a result 122 of execution of the program module 120 to the user device 130. Alternatively, the processor 110 can bring the output to, for example, a database or a storage device 125 such as a memory, or alternatively, to an undepicted remote device over the network 135.

For example, a program for executing the operations in FIG. 7 may be the program module 120. The program can cause the system 100 to operate as the optimization engine 50.

The term “include . . . ” or “ . . . is included” refers to presence of a characteristic, a perfect field, a process, or a constituent element that is stated there, but should be construed as not excluding presence of one or more other characteristics, perfect fields, processes, constituent elements, or a group thereof. The terms “a” and “an” are indefinite articles, and are therefore not to exclude embodiments including a plurality of things stated there.

### OTHER EMBODIMENTS

The present invention is not limited to the above-described embodiments, and can be carried out with various modifications made within a scope that does not depart from the gist of the present invention. In other words, the present invention is not limited to the upper embodiments as they are, and can be embodied by modifying the constituent elements within a scope that does not depart from the gist of the present invention in a stage of implementation.

Moreover, various inventions can be formed by appropriately combining the plurality of constituent elements disclosed in the above-described embodiments. For example, some constituent elements can be eliminated from all of the constituent elements shown in any of the embodiments. Moreover, constituent elements in different embodiments can be appropriately combined.

### REFERENCE SIGNS LIST

11 Terminal
11a Terminal information notification unit
11b Network selection unit
12 Access network (NW)
12a Terminal selection unit
12b Network information notification unit
13 Higher-level network
50 Optimization engine
51 Information collection unit
52 Search candidate selection unit
53 Quality estimation unit
54 Objective function evaluation unit
55 Evaluation result determination unit
56 Optimal network notification unit
100 System
101 User
105 Computer
110 Processor
115 Memory
120 Program module
122 Result
125 Storage device
130 User device
135 Network
140 Storage device
150 Data source
301, 302 Communication system

1. An optimization engine in a communication system, the communication system having a configuration in which each of a plurality of terminals connects to a higher-level network via any one of a plurality of access networks, the optimization engine comprising:
a processor; and
a storage medium having computer program instructions stored
thereon, when executed by the processor, perform to:
collects, from each of the access networks, communication quality information and a network feature, and collects, from each of the terminals, accessibility information indicating which of the access networks is accessible;
generates, based on the accessibility information, connection destination candidates that are candidates for the access networks to which the terminals respectively connect;
estimates, based on the communication quality information, communication quality with respect to the connection destination candidates to obtain estimated communication quality; and
determines optimal connection destinations from among the connection destination candidates, based on a calculated value obtained by substituting the network feature and the estimated communication quality into a preconfigured objective function,
wherein when a specific access network over which a specific application can be used is uniquely determined from among the access networks,
treats a fact that the terminal using the specific application connects to the specific access network, as a fixed value, and generates the connection destination candidates.

2. The optimization engine according to claim 1, wherein the computer program instructions further perform to determines that the optimal connection destinations are the connection destination candidates that give a maximum value or a minimum value of the objective function.

3. The optimization engine according to claim 1, wherein the computer program instructions further perform to outputs a connection instruction to at least one of each of the terminals and each of the access networks such that connections between the terminals and the access networks match the optimal connection destinations.

4. An optimization method for a communication system, the communication system having a configuration in which each of a plurality of terminals connects to a higher-level network via any one of a plurality of access networks, the optimization method comprising:
collecting, from each of the access networks, communication quality information and a network feature, and collecting, from each of the terminals, accessibility information indicating which of the access networks is accessible;
generating, based on the accessibility information, connection destination candidates that are candidates for the access networks to which the terminals respectively connect;
estimating, based on the communication quality information, communication quality with respect to the connection destination candidates to obtain estimated communication quality; and
determining optimal connection destinations from among the connection destination candidates, based on a calculated value obtained by substituting the network feature and the estimated communication quality into a preconfigured objective function,
wherein when a specific access network over which a specific application can be used is uniquely determined from among the access networks, a fact that the terminal using the specific application connects to the specific access network is treated as a fixed value, and the connection destination candidates are generated.

5. The optimization method according to claim 4, wherein it is determined that the optimal connection destinations are the connection destination candidates that give a maximum value or a minimum value of the objective function.

6. The optimization method according to claim 4, further comprising outputting a connection instruction to at least one of each of the terminals and each of the access networks such that connections between the terminals and the access networks match the optimal connection destinations.

7. A non-transitory computer-readable medium having computer-executable instructions that, upon execution of the instructions by a processor of a computer, cause the computer to function as the optimization engine according to claim 1.
